(19) United States
(12) Patent Application Publication
(10) Pub. No.: US 2022/0372637 A1
(43) Pub. Date: Nov. 24, 2022

(54) Process and Apparatus for Production of Ozone

(71) Applicants: Peter A. Barratt, Overton (GB); Richard J. Fraser, Penryn (GB); Oxi-tech Solutions Limited, Penryn (GB)

(72) Inventor: Peter A. Barratt, Overton (GB)

(21) Appl. No.: 17/758,490

(22) PCT Filed: Jan. 15, 2021
(86) PCT No.: PCT/GB2021/050096

§ 371 Date: Jul. 7, 2022

(30) Foreign Application Priority Data
Jan. 14, 2020 (GB) 2000495.8
Jan. 14, 2020 (GB) 2000499.0

(51) Int. Cl. C25B 1/13; C02F 1/467; C25B 9/15

(52) U.S. Cl. CPC C25B 1/13; C02F 1/4672; C25B 9/15; C02F 2201/46115; C02F 2201/782; C02F 2209/23

(57) ABSTRACT

The invention relates to an apparatus for generating ozonated water. In particular, the apparatus is able to efficiently produce ozonated fluids in either continuous or batch operation modes, in a fashion that minimises electrolytic cells degradation, and/or that enhances the accuracy of ozone detection.

### CROSS REFERENCE TO RELATED APPLICATIONS

This application is a national stage of PCT Patent Application No. PCT/GB2021/050096, filed Jan. 15, 2021, which claims priority to UK Patent Application No. 2000495.8, filed Jan. 14, 2020, and UK Patent Application No. 2000499.0, filed Jan. 14, 2020, the disclosures of which are incorporated by reference herein in their entirety.

### FIELD OF INVENTION

The invention relates to apparatus for, and methods of, manufacturing ozone and ozonated fluids for use in a range of applications. Typically, the apparatus and methods produce ozone and ozonated fluids for use in disinfection.

### BACKGROUND

In many disinfection operations, the conventional approach is to: source, package, transport and apply chemical disinfectants for a particular requirement. Such chemicals are conventionally used in a range of applications including, but not limited to: clean-in-place (CIP) operation for industrial equipment; surface cleaning; the treatment of water for drinking; upgrading natural water (such as rainfall, runoff or borehole water); and treating pipework and tanks to avoid the proliferation of bacteria and other pathogens.

The carbon footprint and other issues associated with such conventional chemical treatments is often significant. Raw materials must be sourced and refined (often using complex processes with associated safety and energy considerations); suitable packaging materials must be manufactured; recycling and disposal considerations must be borne in mind; the downstream applications of any treated materials must be considered, as residue or reaction by-products of disinfectants may have adverse effects on the environment or public health; such materials must be transported to point of use; and materials need to be stored in preparation for use (which can itself create safety risks and waste if disinfectants have a short shelf-life).

Moreover, the chemicals used often contain chlorine, which tends to persist in the environment, as well as causing tainting of water and products coming into contact with it. By-products of chlorine-based disinfection are also known to be toxic, persist in the environment, and can be carcinogenic. Typical chemical disinfectants include: sodium hypochlorite, chlorine dioxide, peracetic acid, quaternary ammonium compounds and the like. Often, these chemicals cause harm when contacted with skin and eyes. Burns are often a feature of poor chemical handling practices, leaks and spillages.

Whilst many disinfectants have been developed that are less harmful to the environment and the general public, this approach stills presents difficulties.

One solution that has been developed to solve this problem is the use of ozone and ozonated fluids. It is known that ozone has powerful disinfecting properties and that it is relatively short-lived. Accordingly, ozone can be synthesised and a target fluid or surface exposed to it in order to promote disinfection. Moreover, it is also known to use electrochemistry as a means of generating ozone in situ. Examples of existing in situ ozone generating technology are referenced and described in, for instance, WO2012156671A.

Despite the many advantages of ozone, wide spread adoption of the technology has not taken place. There is a desire to provide an ozone disinfecting system which is able to produce sufficient ozone to solve a variety of disinfection problems and to do this in an efficient and reliable manner (and at the scales necessary to meet the disinfection challenges of industry).

The invention is intended to overcome, or at least ameliorate, these challenges.

### SUMMARY OF INVENTION

There is provided, in a first aspect of the invention, an apparatus for use in the production of ozone, the apparatus comprising: i) a fluid manifold; and ii) a plurality of electrolytic cells within the fluid manifold; characterised in that each of the electrolytic cells are independently switchable between an on state and an off state.

The inventors have found that, by employing several electrolytic cells, the rate of ozone generation can be tuned by selectively activating a number of cells, rather than fine tuning the amount of current and/or voltage delivered to, for example, a single larger electrolytic cell (or the flow rate of aqueous solution passing through the cell). As one skilled in the art would appreciate, electrolytic cells degrade over time and the rate of degradation is often variable. Moreover, operating an electrolytic cell in a variety of different modes can further increase the rate of degradation. By employing several electrolytic cells, each of which is typically configured to operate in a single mode, this problem is alleviated. Cell performance can be monitored and degradation can be ‘averaged out’ across multiple cells by selectively switching cells, at different stages of degradation, off and on. Similarly, the cells can be operated to prevent any one electrolytic cell from being overworked. In addition, failures in individual cells (for instance a damaged electrode or cell membrane) do not halt operation of the system and, in many configurations, do not even necessitate shutdown in order to perform maintenance. Indeed, if a given electrolytic cell becomes sufficiently damaged, the cell can typically be isolated and replaced without interrupting the operation of the apparatus.

As one skilled in the art would appreciate, the term “fluid manifold” is intended to encompass any network of pipes, tubules, conduits, chambers and the like within which fluids can be circulated. Typically, the “fluid manifold” is adapted for use with aqueous solution. The fluid manifold may be composed of a single conduit or chamber.

Alternatively, the fluid manifold may be composed of a series of interconnected conduits and/or chamber describing one or more flow pathways.

For the avoidance of doubt, the term “electrolytic cell” or “electrolytic cells”, used herein, is intended to describe an electrochemical cell(s) capable of performing electrolysis. Typically, the electrolytic cells of the invention are configured to electrolyse water. As one skilled in the art will appreciate by calibrating the current and voltage across the cell, it is possible to create ozone from a water source.

There is no particular limitation on the number of electrolytic cells employed in the invention. However, typically the number of electrolytic cells is in the range of 2 to 1000, more typically 2 to 500, even more typically 2 to 100. It may be that in the range of 3 to 50 electrolytic cells are employed, though it is typically the case that 4 to 40 electrolytic cells are used. In some instances, in the range of 5 to 30 electrolytic cells are used. For some applications, the number of electrolytic cells is 10 or fewer.

The electrolytic cells are positioned within the fluid manifold such that, during operation of the apparatus, a stream of fluid (typically an aqueous stream) passes through the electrolytic cells, undergoing electrolysis as it passes through. There is no particular restriction on the orientation of the cells within the fluid manifold, provided that the stream of fluid is exposed to the electrolytic cells as it passes through the manifold.

The term “independently switchable” is intended to describe the concept that each electrolytic cell can be changed, alternatively, between a first mode and a second mode in a fashion entirely separate from the behaviour of the other electrolytic cells. Moreover, it is typically the case that each electrolytic cell is configured to operate in only two states. Specifically, one on state and one off state. In particular, it is desirable in some applications that said one on state is fixed. That is to say, the current and voltage supplied to the electrolytic cell is configured to produce ozone at one specific rate. Accordingly, by selectively activating one or more of the electrolytic cells, at a certain frequency, a wide range of ozone concentrations can be achieved without the need to vary the electrical input delivered to a given electrolytic cell. That said, in some versions of the apparatus, changes to the electrical power supply can be made to specific cells if necessary.

References to an “on state” as used herein is intended to describe situations wherein an electrolytic cell is delivering ozone into the fluid stream passing therethrough. References to an “off state” as used herein is intended to describe situations wherein an electrolytic cell is not delivering ozone into the fluid stream passing therethrough. As one skilled in the art will appreciate, if no electrical power is supplied to the electrolytic cells, no ozone can be delivered to the fluid stream passing therethrough. However, the electrolytic cells can also be prevented from contributing ozone to the fluid stream by preventing the fluid stream from being diverted through a given electrolytic cell. This can be achieved, for example, using a valve arrangement within the fluid manifold. As such, the “on state” and “off state” referred to herein does not simply describe a lack of provision of electrical power to an electrolytic cell.

In some embodiments, the fluid manifold may further comprise one or more flow cut-off switches. Typically, the flow cut-off switch is a mechanical switch which interrupts the supply of electrical power to one or more of the electrolytic cells when the flow of fluid through the electrolytic cells passes below a given threshold value. This is advantageous as it reliably prevents the electrolytic cells from operating when insufficient flow is provided or when dry (which can cause damage to the apparatus). Usually, the cut-off flow switches will be positioned up stream of the electrolytic cells. Most often, each electrolytic cell has its own cut-off switch.

It is typically the case that the apparatus further comprises a controller in communication with the plurality of electrolytic cells and/or the fluid manifold. The controller is configured to switch the electrolytic cells between states. For the avoidance of doubt, the term “configured to” as used herein is intended to describe the behaviour of, or the method of operation of, a given feature. Terms “arranged to” or “adapted to” may also be used synonymously with the phrase “configured to”. As explained above, the on state and the off state do not exclusively relate to the provision, or lack of, electrical power to an electrolytic cell. As such, the controller may be in communication with the manifold, the plurality of electrolytic cells or both in order to perform its function. Typically, there is only one controller. The controller may receive information from the plurality of electrolytic cells, the manifold or other elements of the apparatus, indicative of the status of the apparatus and/or the fluid stream passing through the manifold. The controller may be configured to maintain a given concentration of ozone in a fluid stream. The controller may be adapted to selectively operate the apparatus in order to manage the health of each of the electrolytic cells. In some embodiments, the controller can be manipulated remotely. Often, the fluid manifold comprises one or more sensors to provide said information to the controller.

It is often the case that each of the electrolytic cells within the plurality of electrolytic cells are provided in series. That is to say that each of the electrolytic cells are positioned along the same flow path, for example, wherein the fluid manifold includes a single conduit and each electrolytic cells is downstream from the next. This is advantageous in applications where complex fluid manifolds are not desirable.

Alternatively, the electrolytic cells within the plurality of electrolytic cells may be provided in parallel. That is to say that each of the electrolytic cells are positioned along different flow paths. For example, multiple conduits may be provided leading to a common output, wherein each conduit comprises an electrolytic cell; or, wherein a single conduit is provided with multiple electrolytic cells positioned in the same conduit, at the same in-stream position, adjacent to one another, so as to create multiple flow paths. Parallel arrangements are advantageous for several reasons, not least because individual electrolytic cells can be easily isolated without disrupting the operation of the apparatus.

It may be the case that a mixture of series and parallel systems are employed. However, more typically, either a series or a parallel arrangement will be used. Most typically, a parallel arrangement is employed.

The electrolytic cells of the invention typically possess a cathode and an anode. These are typically separated by an ion exchange membrane (most typically a proton exchange membrane). As one skilled in the art will appreciate, as fluid passes through the electric field generated by an electrolytic cell, electrochemical reactions are promoted and charged species migrate towards the positive or negative electrodes. The ion exchange membrane prevents certain materials from migrating. Whilst it may be the case that some or all of the electrolytic cells comprise a common anode or a common cathode (i.e. wherein each electrolytic cell comprises only a single independent electrode) it is usually the case that each electrolytic cell comprises its own cathode and its own anode. It may also be the case that each of the electrolytic cells comprises a common ion exchange membrane. This configuration is especially useful in series arrangements of the electrolytic cells. However, more commonly, each electrolytic cell comprises its own ion exchange membrane.

In some cases, the fluid manifold further comprises one or more conduits and each of the electrolytic cells are contained within a common conduit within the fluid manifold. The fluid manifold may be equipped with many conduits each of which may define several fluid pathways. However, it is not necessary that each conduit must contain an electrolytic cell. Electrolytic cells can be arranged in a single conduit, in parallel or in series. The conduits are not restricted to any particular dimensions or geometries.

It may be that the fluid manifold further comprises one or more conduits and each of the electrolytic cells are contained within a different conduit within the fluid manifold.

This embodiment is advantageous for several reasons. For instance, by providing an electrolytic cell in each conduit within the fluid manifold, cells can be turned off and on by closing and opening (respectively) valves within the fluid conduit to prevent or permit the flow of fluid therethrough. Such a system may be employed alone or in combination with the supply or restriction of electrical power to the electrolytic cells as a means of controlling the state of the electrolytic cells.

For the avoidance of doubt, reference to a “common conduit” refers to a single vessel, typically comprising a single lumen, that may include one or more fluid pathways therein.

Accordingly, it may be the case that the fluid manifold further comprises one or more valves for controlling the passage of fluid through the fluid manifold. Said valves are not limited to controlling flow specifically to or from the electrolytic cells. However, this may be the case.

Typically, the on state and the off state are an electrically on state and an electrically off state respectively. That is to say that: the on state represents an electrolytic cell which is both supplied with a flow of fluid and is electrically powered enabling it to perform its electrolysis function; and the off state represents an electrolytic cell which may, or may not, be supplied with a flow of fluid and is not electrically powered. Whilst the flow of fluid to the electrolytic cells can be restricted in a variety of ways, it is typical that the sole mechanism for switching the electrolytic cells between an on state and an off state is electrical. This avoids the number of moving parts necessary in the fluid manifold and reduces the complexity in maintaining a suitable pressure within the fluid manifold. It also ensures that electrolytic cells are never operated in dry or enclosed environments.

Notwithstanding the above, the invention also provides for configurations in which the on state and the off state are a mechanically on state and a mechanically off state respectively. That is to say that: the on state represents an electrolytic cell which is both electrically powered, enabling it to perform its electrolysis function, and supplied with a flow of fluid; and the off state represents an electrolytic cell which may, or may not, be supplied with electrical power but is not supplied with a flow of fluid. This is advantageous for a number of reasons, such as wherein continuous operation of the electrolytic cells is required or desirable.

It is often the case that the electrolytic cells are substantially the same. For the avoidance of doubt, this is primarily a similarity in ozone generating capacity. As one skilled in the art would appreciate, utilising multiple substantially similar cells allows for a greater degree of interchangeability. If one cell is damaged, a corresponding cell from a supply of new cells can be introduced into the existing infrastructure, whichever cell in particular happens to break down. Moreover, by adopting a plurality of substantially similar electrolytic cells, the power supply apparatus necessary to operate the cells can be more easily configured as each electrolytic cell has substantially the same properties. Further still, by employing cells that are substantially the same, it is easier to monitor the degradation of each cell and manage cell operation so as to spread the degradation across the entire apparatus.

Typically, the electrolytic cells comprise an anode and a cathode configured such that, in use with an aqueous solution, ozone is produced at the anode and hydrogen is produced at the cathode. As one skilled in the art would appreciate, the electrical power supplied to the electrolytic cells is typically adapted, to have the correct voltage and current, such that ozone is produced at the anode. Ozone has a comparatively short life-time in situ compared to hydrogen. Moreover, hydrogen is not very soluble in water and so, if not removed, can be expected to build up to excess levels comparatively quickly within the fluid manifold. As such, it is often the case that the fluid manifold includes a vent for releasing any build-up of gas. The gas may be combusted before being ejected from the apparatus. Usually, each of the electrolytic cells further comprises an ion exchange membrane between the anode and the cathode. Typically, the ion exchange membrane will be a proton exchange membrane.

It is often the case that the apparatus may further comprise a plurality of power supply units wherein each power supply unit provides power independently to each of the electrolytic cells respectively. Providing a separate power supply unit for each electrolytic cell ensures that each cell can be independently switched from an off state to an on state, without the need for a central control unit to co-ordinate the distribution of power. The power can be delivered to each electrolytic cell directly; or may be connected to the suitable portions of the fluid manifold to manipulate the flow path of fluid passing through the manifold in order to independently switch the electrolytic cells between a mechanically on and a mechanically off state. In some cases, a combination of these two approaches is employed. The amount of power supplied to the electrolytic cells is calibrated so as to promote the formation of ozone. One skilled in the art would appreciate that numerous factors will influence the exact power supplied to the electrolytic cells, including: the dimensions and surface area of the electrodes, the number of electrolytic cells, the amount of ozone required per minute, the fluid flow rate, the materials from which the electrolytic cells are fabricated, as well as the temperature and composition of the fluids involved. However, typically, the electrolytic cells are supplied with a current density of 50 to 1000 mA cm⁻².

Whilst a controller is not essential, it is most often the case that a controller is provided to coordinate the distribution of power to the electrolytic cells. Moreover, the controller is typically adapted to receive information indicative of the health and operation of the apparatus and, based on said information, distribute power to the apparatus accordingly. For example, the fluid manifold may be equipped with one or more sensors adapted to monitor ozone concentration within the fluid at a given point within the fluid manifold. Sensors may also monitor the performance of each electrolytic cell, and based on this information, the controller may decide how best activate the electrolytic cells in order to achieve a given ozone concentration. Similarly, the sensors may be employed to monitor a range of parameters including: ozone concentration, hydrogen (gas) concentration, ion-exchange membrane integrity, fluid flow rate, fluid pressure, fluid temperature, electrolytic cell health, or combinations thereof. The controller may also be responsible for the mechanical operation of the apparatus, responsible for actuation of any valves and pumps present within the system, and governing when the apparatus should release ozonated fluid for a given application. The controller may decide when a cleaning operation should be performed and may also provide an indication as to when a given electrolytic (or other component) requires maintenance or replacement. Often, the controller is equipped with a user interface or display which enables an operator to monitor the behaviour of the apparatus and/or input particular requirements into the controller.

The apparatus may also include a pump or series of pumps. The pump is used to facilitate movement of fluid through the fluid manifold. There is no particular limitation on the type of pump that can be employed and the person skilled in the art would be familiar with the types of pumps that can be used based on the particular orientation and configuration of the fluid manifold.

It is typically the case that the apparatus includes an inlet for an aqueous solution. This may be a water source, such as mains water, which is treated to create an ozone solution for use in the sterilisation of a given environment. Alternatively, an aqueous fluid for treatment is be administered directly into the apparatus. However, this latter option is less frequently employed as certain fluids for treatment contain particulates or other materials which may cause clogging of conduits or ion-exchange membranes.

Often, the fluid manifold will include a chamber in which a volume of ozonated fluid can be stored and continually maintained at a given ozone concentration. Said chamber typically comprises a vent for gases and an outlet through which ozonated fluid can be supplied for a given application.

There is provided in a second aspect of the invention, an apparatus for use in the production of ozone, the apparatus comprising: i) a fluid manifold; ii) one or more electrolytic cells within the fluid manifold; and iii) a tank within the fluid manifold; characterised in that the fluid manifold further comprises a flow cell, said flow cell comprising an ozone sensor.

The inventors have found that conventional ozone generation systems do not provide accurate readings with regard to the concentration of ozone present in a solution, especially where sensors are placed in large chambers. For example, it has been found that ozone sensors positioned within tanks will often suffer from bubble accumulation on the sensor. Consequently, this produces inaccurate readings of dissolved ozone. In light of this discovery, the inventors have found that, by placing a flow cell within the fluid manifold, it is possible to avoid this phenomena and so achieve more accurate readings as to the ozone concentration of the fluid.

The term “flow cell” is intended to take its usual meaning in the art. That is to say, a fluid channel, typically of much smaller cross-sectional area than the majority of conduits and/or chambers within the fluid manifold, through which fluid can be passed. Typically, the volume of fluid passing through the flow cell is comparatively small compared to the bulk of the fluid within the fluid manifold (and more typically is comparatively small in comparison to the chambers and conduits of the fluid manifold). As one skilled in the art would understand, the narrower dimensions of the flow cell minimises the formation of bubbles and provide an environment better suited to accurate testing of the fluid. Typically, the flow cell is adapted to receive a volume of fluid less than or equal to 50 ml per second, more typically less than or equal to 40 ml per second, even more typically less than or equal to 30 ml per second, and most typically less than or equal to 10 ml per second.

The positioning of the flow cell is not especially important. However, it is typically the case that the flow cell is positioned near the tank. Whilst the concentration of ozone in a fluid circulating through the apparatus is generally homogeneous, as one skilled in the art would appreciate, because ozone will naturally decay to form more stable oxygen species, there will usually be some variation in ozone concentration throughout the fluid. This is the case even where mixing apparatus is employed within the system. As ozonated fluid is typically stored and supplied for various applications from the tank, it is desirable that the flow cell is positioned so as to sample fluid within the tank. Accordingly, the flow cell will typically be positioned immediately upstream of the tank, immediately downstream of the tank or connected to the tank itself. Most typically, the flow cell will be connected to the tank, for instance via a side channel. As the flow cell typically has a small cross-sectional area, it is usually the case that the flow cell forms a parallel fluid pathway to the main fluid pathway or pathways through the apparatus. This avoids a build-up of back pressure that would otherwise occur if the entire fluid volume were funnelled through the flow cell.

There is no particular limitation on the type of ozone sensor that is employed in the invention and a person skilled in the art would be familiar with the kind of ozone sensors compatible with the apparatus.

It is often the case that the tank comprises a vent. As one skilled in the art will appreciate hydrogen gas is a by-product of the electrolysis process which must be removed safely from the system. As such, the tank typically includes a vent. This vent will usually vent gas directly to atmosphere. However, the invention also encompassed embodiments wherein this hydrogen is captured. Typically, the tank is open to the atmosphere. That is to say, the process is not typically performed in a hermetically sealed system. This is advantageous as it mitigates the pressure management requirements in the system and avoids risks associated with the build-up of gases in a confined space.

Typically, the tank comprises an inlet for the receipt of an aqueous solution. Further, the tank also comprises an outlet for ozonated fluid. This configuration is advantageous because it allows for the apparatus to be effectively operated in both a continuous mode and batch mode. For example, in a continuous mode, an aqueous solution is delivered constantly to the tank whilst ozonated fluid is drawn from the tank. It is typically the case that the tank is equipped with mixing apparatus in order to ensure homogeneity of the fluid contained therein. This is especially useful in continuous operation as non-ozonated aqueous solution is constantly delivered to the tank whilst ozonated fluid is leaving the tank. In such scenarios, it is typically the case that electrolytic cells and/or the mixing apparatus are controlled so as to maintain a substantially constant ozone concentration in the fluid leaving the tank. The mixing apparatus can take various forms. This may be in the form of a mixing element within the tank (that physically agitates the fluid); or the apparatus may rely upon the inherent mixing resulting from the movement of fluid through the fluid manifold to produce the necessary mixing.

Typically, the fluid manifold comprises a pump adapted to move fluid through the electrolytic cells and provide mixing energy to the contents of the tank. As one skilled in the art will appreciate, pumps are useful in moving fluid through the fluid manifold. There is no particular limitation on the type of pumps employed. It may be the case that, in order to effect mixing of the fluid, the fluid manifold contains passive mixing regions, such as baffles, which stimulate mixing as fluid is moved through them under the impetus of a pump. Alternatively, or in addition to these passive mixing systems, active mixing systems (such as stirrers) may be included within the fluid manifold.

Often, the fluid manifold includes a treatment loop adapted to clean the plurality of electrolytic cells. During operation, various impurities in the aqueous solution may clog, or otherwise inhibit, the operation of the electrolytic cells. For instance, salts may form on the electrodes which impede the operation of the electrolytic cells. The conduits of the fluid manifold may also become blocked or constricted with the build-up of material. Accordingly, it is typically the case that the apparatus includes a supply of cleaning agents which can be introduced into the fluid pathways for circulation. Typically, this will be done when the electrolytic cells are in an electrically off state and when the apparatus is not producing ozonated fluid (to avoid contaminating the ozonating fluid with cleaning agents). However, depending upon the cleaning agents and/or the application intended for the ozonated fluid, the cleaning agents may be administered during normal operation.

It may be the case that the treatment loop comprises a cleaning agent reservoir and a valve to control the administration of the cleaning agent to the apparatus. The treatment loop may be controlled by the controller. Moreover, based on the information provided to the controller, the controller may initiate a treatment operation.

Additionally, the apparatus of the invention may also comprise a chiller, adapted to lower the temperature of fluid: entering the apparatus, circulating or retained within the apparatus, being discharged from the apparatus, or any combination thereof. As one skilled in the art would appreciate, ozone breaks down more readily at higher temperatures. Accordingly, especially where the apparatus is used in warm climates, the chiller can cool the fluid (directly or indirectly) in order to slow the rate of ozone degradation. Typically, the chiller is adapted to keep the fluid below 40° C.

It is also the case that the apparatus may be equipped with a filter to prevent solids suspended within any incoming aqueous solution for treatment from entering the apparatus. The apparatus will typically have a certain tolerance to some degree of solid suspension within the fluid to be treated. However, above a certain threshold, such matter can clog the fluid manifold, block the ion-exchange membrane of the electrolytic cells, and otherwise interfere with good operation of the apparatus.

The apparatus of the invention can be used for a wide range of applications. However, typically, the ozonated fluid generated by the apparatus is used in various sterilisation applications. Examples of systems with which the apparatus is typically compatible include, but are not limited to: milking equipment, sewage treatment equipment, brewing equipment, domestic and commercial pipework, laboratory equipment, or combinations thereof.

Those features described with respect to the first aspect of the invention, indicated as typical or otherwise, are also understood to be compatible with respect to the apparatus of the second aspect of the invention. For instance, the apparatus of the second aspect of the invention may include a controller. Similarly, a plurality of electrolytic cells may be employed (and said cells may also be independently switchable) with respect to the first aspect of the invention.

In addition, those features described with respect to the second aspect of the invention, indicated as typical or otherwise, are also understood to be compatible with respect to the apparatus of the first aspect of the invention. For instance, the first aspect of the invention may employ the tank mentioned with respect to the second aspect of the invention. The first aspect of the invention may similarly make use of the flow cell arrangement described with respect to the second aspect of the invention.

It may be the case, with respect to either the first aspect or second aspect of the invention, that components of the apparatus are divided into a dry compartment and a wet compartment. Typically, those components responsible for electrical actuation of the electrolytic cells, and the electrolytic cells themselves, are housed in a dry compartment (in order to minimise the likelihood of electrical shorts and other safety issues). Similarly, the controller is typically housed within the dry compartment to protect it from exposure to aqueous fluids. For the avoidance of doubt, a dry compartment does not refer to a region in which no fluid carrying conduit is present. It refers to the fact that elements of the fluid manifold contained therein are sealed so that neither water from without (of the compartment), nor water from within the fluid manifold, can enter the compartment. Power supply units may also be located within the dry compartment. Other areas of the fluid manifold, such as those near the tank and/or the flow cell, need not be contained within the dry compartment. Accordingly, these may be housed in a specific wet compartment, fluidly disconnected from the dry compartment. Alternatively, said wet compartment regions may not be confined to any compartment.

There is provided in a third aspect of the invention, a process for the production of an ozonated solution, the process comprising the steps of: i) providing an apparatus according to the first or second aspect of the invention; ii) providing an aqueous solution to the apparatus; and iii) electrolysing the aqueous solution using an electrolytic cell to generate ozone.

Typically, the aqueous solution is mains water. There is no particular temperature at which the process may be conducted. However, typically, the process will be performed between a temperature in the range of 10° C. to 40° C., and more typically in the range of 15° C. to 35° C.

The process may be performed as a continuous process or a batch process.

There is also provided, in a fourth aspect of the invention, a computer program comprising instructions which, when the program is executed by a computer, causes the computer to carry out the method according to the third aspect of the invention.

As one skilled in the art would appreciate, the controller typically comprises a computer on which the computer program is executed. The controller is adapted to receive information indicative of a variety of parameters relating to the health and operation of the apparatus, and on the progress of the electrolytic processes being performed. Based on this information, the program may instruct the apparatus to operate in a particular way in order to achieve a desired outcome.

Typically, the program is a non-transient computer program.

Moreover, it is typically the case that the program moderates the rate of ozone generation by independently switching the electrolytic cells between an off state and an on state.

Although the term “comprising” is used herein, it is also contemplated that that the invention may “consist” or “consist essentially of” the same features. Any numerical ranges quoted herein are to be understood as being modified by the term “about”.

In order to aid understanding, preferred embodiments of the invention will now be described with respect to the following figures and examples.

### DESCRIPTION OF FIGURES

FIG. 1 shows a schematic diagram of the apparatus of the invention.

FIG. 2 shows the rate of increase in dissolved ozone (mg l⁻¹) during 3 runs in tap water at slightly increasing temperature.

FIG. 3 shows the effect of increasing temperature during the day (UK summer) on dissolved ozone (mg L⁻¹) over an 840 minute period from when the cell was turned on in clean tap water.

FIG. 4 shows the decline in dissolved ozone concentration over time at 29° C., from the point where the cells were turned off, with water still recirculating through the tank.

FIG. 5 shows the effect of recycle flow rate (l min⁻¹) on dissolved ozone (mg L⁻¹).

FIG. 6 shows the setpoint for dissolved ozone in an analyser was initially 2.0 mg l⁻¹.

FIG. 7 shows dissolved ozone (mg L⁻¹) produced and maintained at 29° C. over the course of 27 hours where ozonated water was drawn off from time to time, and the tank refilled with fresh tap water.

FIG. 8 shows the ozonation of 10 litres of tap water from the start (time zero), where 5 litres was withdrawn and the tank refilled to 10 litres on one occasion.

FIG. 9 shows temperature which is stable over the course of the 32 hour run time, and dissolved ozone.

FIG. 10 shows the effects of restarting the system after two weeks of downtime. The setpoint for DO3 was 2.0 mg l⁻¹.

FIG. 11 shows a general process of the invention.

FIG. 12 shows three electrolytic cells linked in a parallel in a parallel configuration.

FIG. 13 shows three electrolytic cells linked in a series in a parallel configuration.

FIG. 14 shows multiple electrolytic cells used to increase the dissolved ozone concentration in a body of water within a reservoir where water is pumped past the cells within a pipe, and into a water reservoir.

### DETAILED DESCRIPTION

FIG. 1 shows one embodiment of the invention. The apparatus 1 is shown in which a water source 2 (usually mains water) is supplied to tank 3 via inlet 5. The tank is equipped with a vent 6 from which gas is able to escape to the atmosphere. Fluid can be released from the tank via the outlet 7 positioned at the base of the tank. The fluid 4 in the tank 3 is fluidly connected to a first pump 10 via a first valve 9. A second valve 11 is positioned between the first pump 10 and the dry compartment 12. A flow cell 13 is positioned outside the dry compartment 12 comprising a third valve 14 which controls the flow of fluid to an ozone sensor 15. Within the dry compartment 12, a controller is located along with a fourth valve 19 which permits the flow of fluid to electrolytic cells 21, each of which contains an anode, a cathode and a proton exchange membrane (not shown). Only four electrolytic cells 21 are depicted here, however more could be employed. A fifth valve 23 permits the flow of ozonated fluid from the electrolytic cells 21 back into the tank 3.

Fluid 4 from the tank 3 can be released via the outlet 7 and is actuated by the second pump 28 via valve 27 to provide a stream of ozonated fluid 29 for use in a range of applications, usually sterilisation applications.

### Example 1—Experimental

All batches of ozonated water were generated using 2 cells operating in parallel via a variable speed submersible aquarium pump, feeding a 24 litre water tank. The water used was tap water. Dissolved ozone was measured via a sensor in the tank.

### Ozone Generation

Current is applied to the cell to provide a current density enough to promote the production of ozone from the anode. The applied current density was within the range 50 to 1000 mA cm⁻².

### Example 2—Dissolved Ozone Generation

The following sections describe some of the typical data sets concerning the generation of dissolved ozone in tap water.

### Repeatability and the Effect of Water Temperature

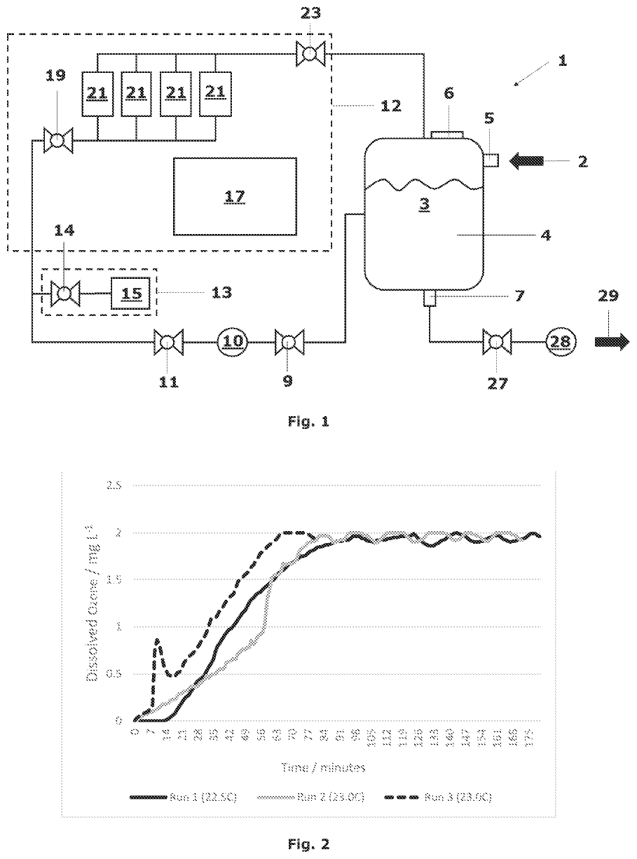

FIG. 2 shows the rate of increase in dissolved ozone (mg l⁻¹) during 3 runs in tap water at slightly increasing temperature. Specifically, it shows that even where there are slight changes in water temperature, the generation of dissolved ozone from the same cell set-up is repeatable.

### Effect of Higher Temperature

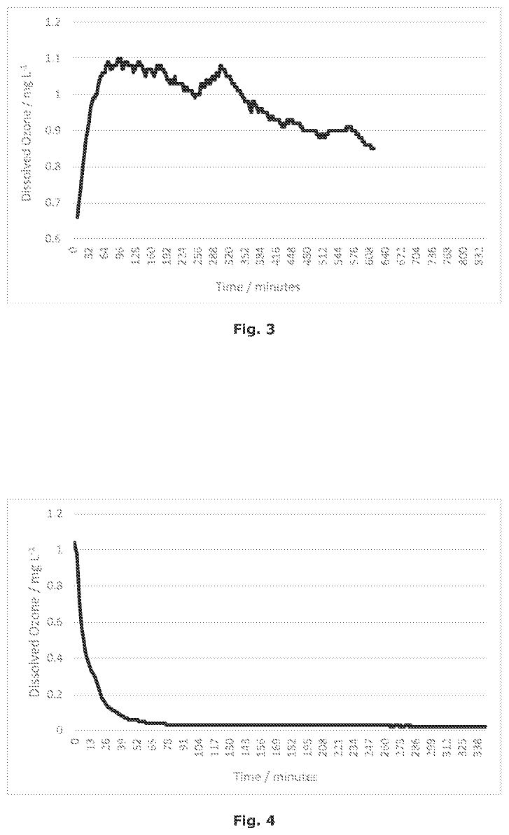

The effect of summer temperatures can be seen in FIG. 3 of dissolved ozone (mg l⁻¹) over an 840 minute period, where, during the run, temperatures rose from 30° C. to 33° C. This temperature profile is a normal feature of the gradual heating effect of the recirculation pump and the cells in a small batch process.

### Effect of Dissolved Ozone Degradation

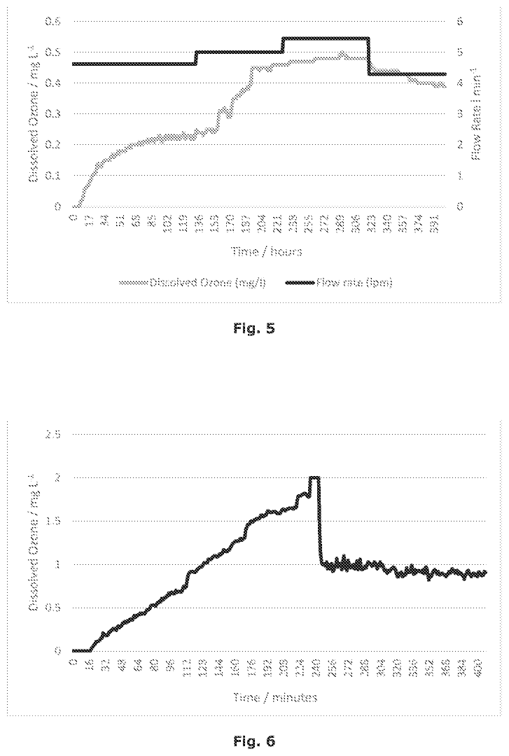

FIG. 4 shows the decline in dissolved ozone concentration over time at 29° C., from the point where the cells were turned off, with water still recirculating through the tank. The data show exponential decline in ozone, and indicates an ozone half-life in the range 8 to 12 min at 29° C.

### Effect of Changing Recirculation Flow Rate

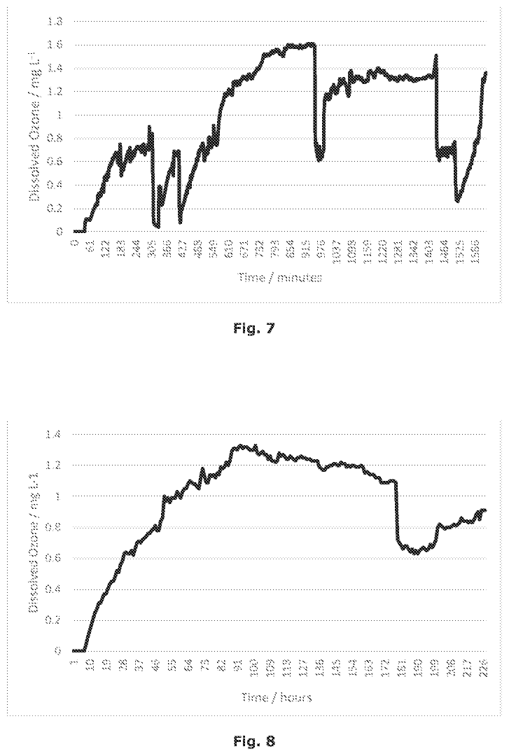

The variable speed drive on the pump was altered to increase and decrease the pump rate in the recirculation loop with one cell. This changes the velocity at which the water passes past the cells. At the start of the experiment, the flow rate was 4.6 litres per minute (l min⁻¹). This was changed to 5 l min⁻¹ (black line, FIG. 5), and then to 5.5 l min⁻¹, and finally to 4.3 l min⁻¹. FIG. 5 shows the effect of recycle flow rate (l min⁻¹) on dissolved ozone (mg L⁻¹).

### Effect of Changing Setpoint

FIG. 6 shows the setpoint for dissolved ozone in an analyser was initially 2.0 mg l⁻¹. Once the setpoint had been reached, the setpoint was reduced to 1.0 mg l⁻¹ and fresh water added to reduce the dissolved ozone concentration to approximately 1.0 mg l⁻¹. This concentration was maintained by the controller, and the data indicates that the dissolved ozone can be controlled within quite tight limits using setpoint control and controller tuning.

### Effect of Sensor Aberration

For all these experiments, the dissolved ozone sensor was positioned in the centre of the tank; submerged under the surface. This was done in order to reduce losses of ozone to atmosphere through an open top sensor flow cell. The penalty of this is that, every so often, there are aberrations in the level of dissolved ozone recorded by the sensor, which show as periodic rapid declines and then increases in dissolved ozone. Without being bound by theory, it is believed that this is due to bubble formation and coalescence around the tip of the sensor.

FIG. 7 shows dissolved ozone (mg l⁻¹) produced and maintained at 29° C. over the course of 27 hours. The data indicate the frailties of the membrane/electrolyte ozone sensors which we are using.

### Effect of Tank Water Top-up

FIG. 8 shows the ozonation of 10 litres of tap water from the start (time zero). As the dissolved ozone concentration plateaus, and declines slightly (likely due to slight temperature increase), the tank is filled to 20 litres with fresh tap water and, as FIG. 8 shows, a subsequent gradual increase in dissolved ozone level (mg l⁻¹) in the increased volume.

### Effect of Mixed Solutions and Changing Conditions

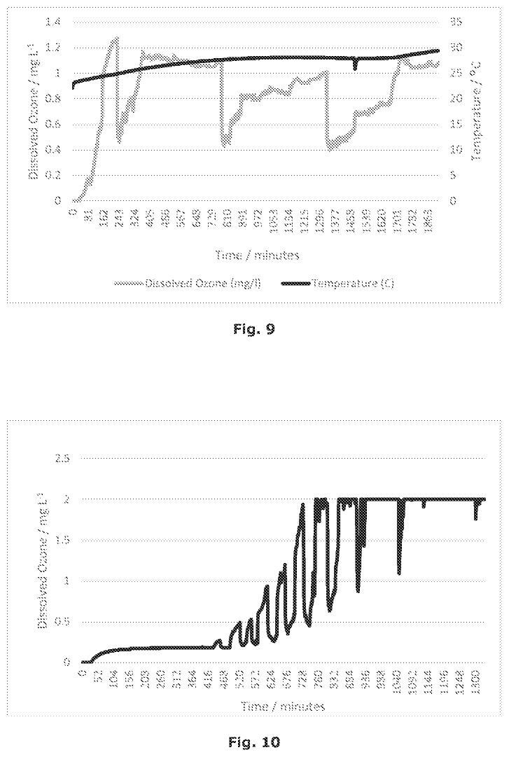

FIG. 9 shows temperature (black line) which is stable over the course of the 32 hour run time, and dissolved ozone (grey line). Dissolved ozone setpoint was 2 mg l⁻¹ but as soon as the concentration reached >1.2 mg l⁻¹, 10 litres of ozonated water were removed, and the tank then refilled to 24 litres with fresh tap water. This was undertaken 3 times which can be seen by the drop in dissolved ozone concentration, which occurred on those 3 occasions. Dissolved ozone after each refill occasion recovered rapidly. Subsequent to these 3 refills, the cell current was increase twice. These can clearly be seen as two rapid increases in the rate and level of ozone in the tank after approximately 1500 and 1600 minutes respectively.

Effect of Restarting System after 2 Weeks Non-Use (DO3 Probe Effect)

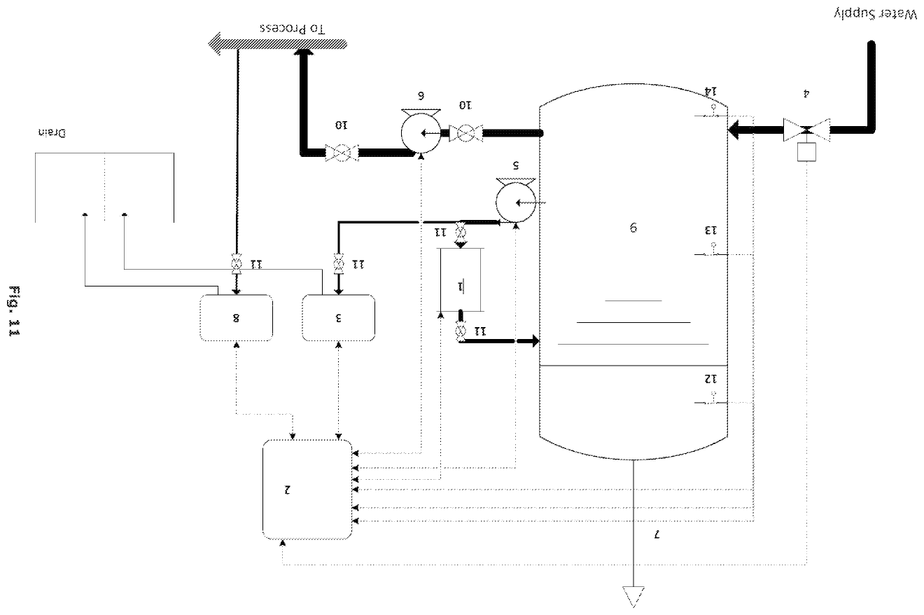

FIG. 10 shows the effects of restarting the system after two weeks of downtime. The setpoint for DO3 was 2.0 mg l⁻¹. Restarting the system after it had been shut down for around 2 weeks showed a slow increase in DO3 followed by a plateau over about 7 to 8 hours, after which measured DO3 began to rise (albeit a very saw-tooth pattern of rise and fall) over the next 7 to 8 hours, until the setpoint was reached. This is clearly an artefact of the DO3 probe settling back into true measurement. The reasons may include biofilm growth on the sensor membrane, the membrane/electrolyte re-equilibrating, or biological growth in the water consuming ozone.

This has ramifications if processes are only using ozone periodically, suggesting that ozone should be run for at least short periods every day to encourage the probe to maintain true DO3 readings.

The invention also provides a process for producing ozonated water as described below.

The process is fed with a source of water. This source may be from any source of clean or partially clean water, such that the water preferably contains a low level of suspended solids and gross organic contamination. Such water may be supplied from a variety of sources, including: a mains water network, stored water from rainfall or run-off, natural bodies of water such as lakes, ponds and rivers, water recycled from a downstream process, condensate, or treated waste water.

The generic process is shown in FIG. 11, where treated water is finally pumped to a downstream process or final point of use via a discharge pump (6). Water enters from the appropriate source and enters the main vessel (9), typically via a control valve (4) which regulates the rate at which water is fed to the process. The vessel acts as both a reaction and mixing vessel for the water and the ozone and other oxidant species generated. The vessel (9) can be open to atmosphere, or closed, but where it is closed, there is provision of a vent line (7) to remove off-gases to an appropriate location away from the main equipment in the process. The process includes a means to provide motive energy to the water in the vessel. Typically, this will be a pump (5) which withdraws water from the vessel and returns it to the vessel, via an electrolytic cell, or manifold of electrolytic cells (1). In some embodiments of the process the pump (5) will be externally mounted (as shown in FIG. 11), and in other embodiments it is a submersible pump situated within the vessel. In either case, the pump feeds water to the electrolytic cells via a recirculation system so that water passing these cells becomes electrolysed and dissolved oxygen based chemical species, particularly ozone, are produced. The electrolytic cell, or cells (1) can be mounted externally or inside the vessel.

As the process operates from initial start-up, the concentration of dissolved ozone increases in the bulk water within the vessel (9), and this is measured by a submerged ozone sensor somewhere within the process; for example at position (3) or (8), which represent flow-cells from where water from the process can be monitored, or within the main vessel (9). In FIG. 11, one embodiment of the invention shows the sensor within an integrated flow cell (3), taking ozonated water from the side-stream recirculation line, and this small flow of water is discharged to drain after analysis for dissolved ozone and any other parameters which may be measured. The signal from this dissolved ozone sensor can be used to control the activation of the electrolytic cell(s) shown (1), via a central control panel and process control module (2), to provide a means of controlling the dissolved ozone concentration within the water in the vessel (9).

Similarly, an ozone sensor (or other sensors measuring relevant parameters) can be placed in a flow cell (8) receiving treated water from a downstream process or collection point. This flow cell (8) and the sensors within it can be used to control residual dissolved ozone, or, for example, parameters of critical interest to the application of the process, such as: microbiological activity, colour or turbidity. Water entering and leaving the vessel (9) can be controlled via level switches (12, 13 and 14) sited within the vessel, in order to avoid over-filling or under-filling during process operations. Feed water to the vessel (9) via the control valve (4) can be continuous, when the removal of ozonated water from the vessel (9) via the discharge pump (6) and valves (10) is also continuous. This is the configuration for operation of a continuous process. Equally, the process may operate as a batch process, where valves (10) are closed, and the discharge pump (6) is off during vessel filling via control valve (4). Once filled to the appropriate level, the water in vessel (9) is treated via the electrical activation of the electrolytic cell or cells (1) in the side-stream until the required concentration of dissolved ozone is reached in the water within the vessel (9). At this point, the treated water can be held at the required dissolved ozone concentration, via control achieved by communication between the ozone sensor (3), control panel (2), electrolytic cell or cells (1), and the side-stream recycle pump (5). Once the downstream process requires the ozonated water, the water within the vessel (9) is released via the discharge valves (10) and the discharge pump (6).

The electrolytic cells (1) used are typically those using boron-doped diamond electrodes separated by a proton exchange membrane. These are operated at current densities conducive to the production of ozone (rather than just oxygen) at the anode. Where multiple cells are used, each cell can be switched on and off independently, either automatically, according to the control parameters within the process and the demand of the process for ozone, or manually.

Embodiments of the invention are also described in the following items:

1a. Dissolved ozone produced in a closed vessel of clean water by a single electrochemical cell or by multiple electrochemical cells, in a pumped side-stream where water is withdrawn from the vessel via a pump or pumps, through pipework in which is inserted an electrochemical cell or cells, and returned to the tank, so that dissolved ozone concentration increases over time, or is held at a stable level within the vessel.

2a. A process as described in item 1a where the process operates in batch or continuous mode, whereby the water in the vessel is ozonated to a specified concentration of dissolved ozone, and then used in a process downstream of the vessel.

3a. A process as described in item 1a where the process operates in batch or continuous mode, whereby the water in the vessel is ozonated whilst make-up water is added at the same time, on a continuous or semi-continuous basis, whilst ozonated water is similarly released to a downstream process on a continuous or semi-continuous basis.

4a. Electrochemical cells mounted externally or inside the vessel in a pipework manifold, where water is recirculated past the cells in equal or similar flow patterns and at equal or similar flow rates, during which they produce ozone (and other by-product gases), which become dissolved in the water.

5a. In item 1a, each electrochemical cell in the process is monitored such that each cell will only receive the required electrical current to activate the electrochemical process, and thus generate the ozone (and other gases) when water is flowing, and when the ozone concentration in the water within the vessel has not reached a predetermined required concentration of dissolved ozone.

6a. The top of the vessel referred to in items 1a to 5a is closed, but not sealed, such that the gas-filled headspace above the water level contains some of the off-gases from the electrochemical cell, including undissolved ozone.

7a. In item 6a, where these headspace gases are held at a pressure equal to or slightly above that of ambient pressure outside the vessel, and are released in a controlled manner via a vent line.

8a. Where multiple electrochemical cells are used as described in preceding items, these are switched on and off according to a pattern which ensures that each cell is used for a similar amount of time as the process operates, thereby distributing wear on the cells evenly, even where relatively few cells are required to meet the demand of the process, although many more cells may be on standby at any one time.

9a. Water with low suspended solids concentrations supplied to the process in any of the preceding items which may arise from: mains tap water, borehole water, rainwater, river water, water from ponds or lakes, water recycled from another process, or even water generated by the process, then used downstream in another process, and then returned to the process vessel.

10a. The process, as defined by the preceding items where the ozonated water is discharged on demand, on a batch or continuous basis, to a ‘Clean In Place’ process for the disinfection and/or cleaning of pipes and equipment.

11a. The process, as defined in items 1a to 9a, where the sole aim is to treat the incoming water in order to make it suitable for use elsewhere, whereby the untreated water enters the process, and then contacts water already containing dissolved ozone, and is then discharged, after a suitable contact time, either on a batch or continuous basis, to a final point of use.

12a. At all times during operation of the process the electrochemical cells described in preceding items are kept wetted, and receive water above a pre-set minimum flow rate to avoid the possibility of being electrically activated whilst dry.

13a. In item 12a where each electrochemical cell is protected from being electrically activated by a flow switch positioned upstream of the cell, so that under conditions of low flow rate this flow switch stops the flow of water and sends an alarm signal to the process control panel.

14a. As in preceding items, each electrochemical cell is operated such that the voltage across the cell is measured, and maintained within a pre-set range, despite the application of a constant electrical current to each cell.

15a. In item 14a, if the voltage exceeds a high voltage set point, an alarm signal is sent to the process control panel.

16a. In item 1a where the inlets and outlets of the pumped side-stream within the vessel are situated in order to produce even liquid-liquid mixing within the water in the vessel in order to improve the homogeneity of the ozonated water within the vessel to obtain an evenly distributed dissolved ozone concentration throughout the bulk liquid, ensuring that the inlet and outlet of the side-stream within the vessel are spatially separated from one another, and that the overall movement of water within the vessel is in a peripheral, circulatory pattern.

17a. In all preceding items where the vessel is either open to atmosphere or closed but with a vent line allowing off-gases to be vented from the system to an appropriate location or locations.

18a. In all preceding items where the geometry of the vessel is either: cylindrical, spherical, ovoid, cuboid or a shape with multiple vertical sides, such as octagonal in horizontal cross-section, with the height of the vessel being enough to promote adequate mixing and dissolution of the gases formed at the anodes of the electrolytic cells, thus allowing elevated concentrations of dissolved ozone to be achieved.

19a. As in preceding items where the vessel, interconnecting pipework, valves and pumps are constructed in materials where the wetted parts are resistant to chemical reaction with or accelerated corrosion in the presence of dissolved ozone in water, where such materials include: plastics such as High Density Polyethylene, vitreous- or enamel-coated steel, stainless steel, and glass, ceramic or glass-lined material.

20a. In item 1a and subsequent items where each electrochemical cell comprises two electrodes made from boron-doped diamond, separated by a polymeric proton exchange membrane, and supplied by electrical current applied at an elevated current density suited to the production of ozone at the anode.

21a. The process as defined in preceding items, where the concentration of dissolved ozone in the vessel is controlled in order to reach and maintain a predetermined concentration, as measured and controlled by a dissolved ozone sensor or sensors placed within the water in the vessel, where the electrical signal from this sensor(s) is fed to the process control panel, and used as a controlling parameter to turn electrochemical cells on or off according to the dissolved ozone demand of the water in the vessel.

22a. In item 21a where the concentration of dissolved ozone in the vessel is controlled in order to reach and maintain a predetermined concentration, as measured and controlled by a dissolved ozone sensor or sensors placed in a flow-cell mounted externally to the main ozonation vessel, where the electrical signal from this sensor(s) is fed to the process control panel, and used as a controlling parameter to turn electrochemical cells on or off according to the dissolved ozone demand of the water in the vessel.

The invention also provides a use of multiple electrochemical cells to generate dissolved ozone.

Specifically, using multiple electrolytic cells, each of which produces ozone and other oxidant chemical species at the anode of the cell, in order to treat water flowing past the cells, or to raise the dissolved ozone concentration in a body of water for subsequent use downstream of the process described.

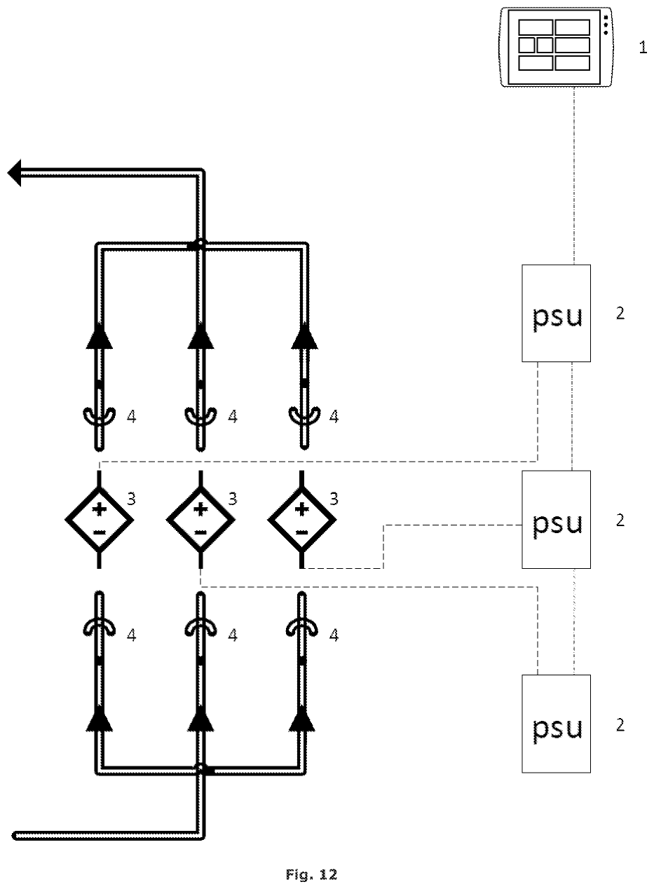

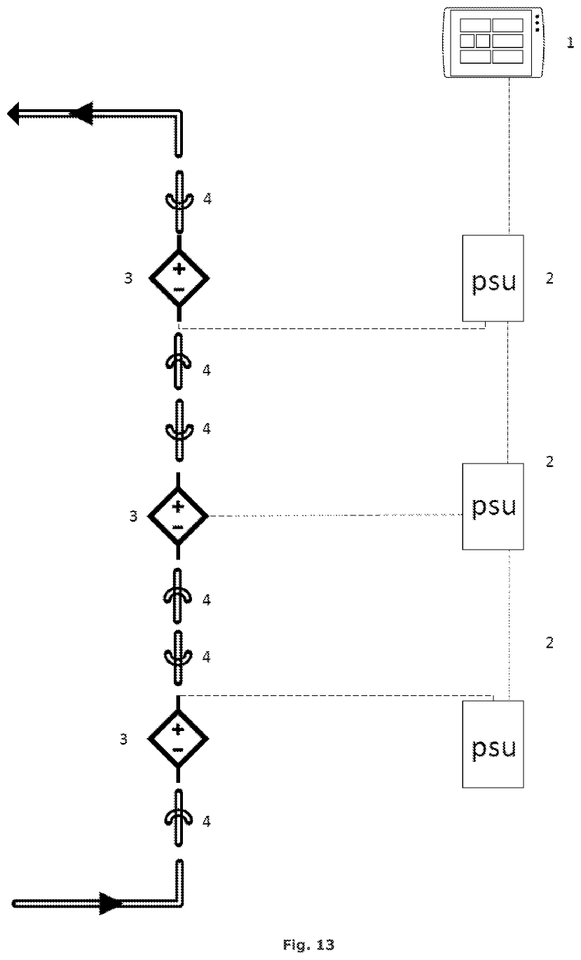

The electrolytic cells are linked and controlled in an array, in a water pipework manifold. The cells are arranged either in parallel (FIG. 12) or in series (FIG. 13) as water flows past them; either in a pipe, or in an open channel.

In FIG. 12, three electrolytic cells (3) are shown linked in parallel in a pipe manifold via connectors (4), such that the flow of water indicated by the direction of flow arrows distributes the water across all three cells. Each cell is powered independently by a power supply unit (2), and each power supply unit is linked via a single control panel (1).

In FIG. 13, three electrolytic cells (3) are shown linked in series in a pipe via connectors (4), such that the flow of water indicated by the direction of flow arrows moves the water across all three cells. Each cell is powered independently by a power supply unit (2), and each power supply unit is linked via a single control panel (1).

In the case where multiple cells are situated in parallel within a single flow of water (FIG. 12) this can be achieved by either placing individual cells within separate pipes which are linked via a manifold, or by multiple, parallel cells situated within a single larger diameter pipe or body of water.

Each electrolytic cell is linked electronically though a programmable logic control programme as shown as (1) in FIGS. 12 and 13, so that each electrolytic cell receives a discrete electrical current as well as a similar flow of water, and preferentially produces ozone and oxygen at the anode, and hydrogen at the cathode, as the water flows past.

Typically, each electrolytic cell comprises an anode and a cathode made from boron-doped diamond, and a proton exchange membrane in between them, allowing the free flow of protons between the two. Each electrolytic cell within the array is operated independently from the other cells, and has a unique electronic signature, in the form of erasable programmable read-only memory, attached to each cell. This read-only memory allows process control software within the control panel, shown as (1) in FIGS. 12 and 13, to identify each cell, monitor its performance as voltage output, and apportion the run time for each cell to maintain a similar run time at any given point for each electrolytic cell in a multiple cell array.

Electrolytic cells are typically rectangular in shape, and oriented in a vertical or horizontal plane, such that water normally flows along the longitudinal plane of each cell, including its electrodes and membrane, and that, when there is little or no water flow, water drains away from each microcell to reduce the growth of microorganisms on the surfaces of the microcell. Any number of electrolytic cells in an array can be isolated, by means of removing electrical current feed and water flow from the cell, at any time. This may occur, for example, when there is a requirement for maintenance. When such isolation occurs, or when a cell fails to operate for any reason, an equivalent number of off-line cells are automatically brought on-line in order to stabilise the production of anodic ozone across the multiple of cells.

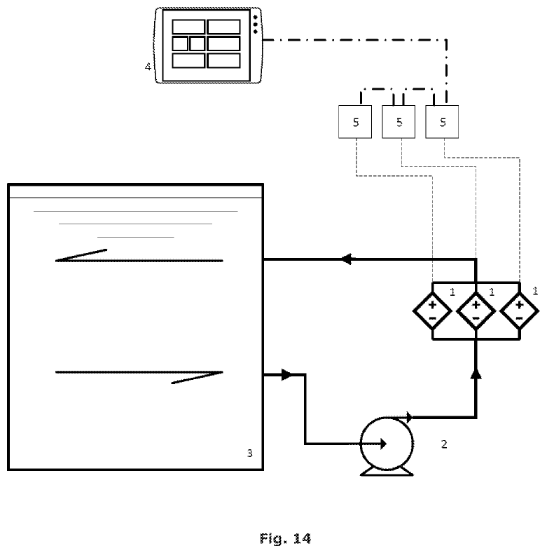

The multiple electrolytic cells may be used to increase the dissolved ozone concentration in a body of water within a reservoir where water is pumped past the cells within a pipe, and into a water reservoir. This is shown in FIG. 14. Water withdrawn from the reservoir (3) from the same pump (2), or pumps, once passing through the multiple of electrolytic cells (1), is then returned to the reservoir (3) and therefore to the inlet side of the pump(s) so that the water now containing dissolved ozone receives further dissolved ozone from that produced at the anode of each cell. In this embodiment, each cell (1) has its own power supply unit (5), and each power supply unit is connected to a control panel (4) via a data communications cable, wherein programmable control software identifies each unique electrolytic cell (1), and controls the operation of the cells to maintain the required concentration of dissolved ozone in the reservoir (3).

Whether in a pipeline or an open channel of water, multiple electrolytic cells are spatially separated from each other.

In a pipe, the cross-section of the pipes is normally circular. In pipes used to house the electrolytic cells, a device to increase flow turbulence, and gas-liquid mixing can be used immediately after the electrolytic cells. This improves dissolution of any gaseous ozone in the gas phase of the pipe. Such devices may include: static mixers, venturis, pipe restrictors and baffles on the inside of the pipe wall.

Each electrolytic cells can be contained within a separate and distinct section of pipe, and each such section is situated in parallel with a neighbouring section of pipe containing another cell. As water flows past each cell, the individual, parallel flows of water from each cell recombine via a manifold to form either a single flow stream, or a single body of water, or both. Electrolytic cells may be situated in a single water flow pipe, where the cross-section of the pipes is preferentially, but not exclusively circular, and the microcells are spatially separated from one another.

Embodiments of the invention are also described in the following items:

1b. Electrolytic cells linked physically, but not electrically, in an array, in a water pipework manifold, either in parallel or in series, and also linked electronically though a programmable logic controller, whereby each cell receives a similar flow of water and discrete electrical current, and preferentially produces ozone and oxygen at the anode, and hydrogen at the cathode as the water flows past the cells.

2b. In item 1b where the electrolytic cells are situated in an open channel of flowing water.

3b. Electrolytic cells as in items 1b and 2b, where each cell is switched on and off according to required dissolved ozone concentration downstream of the cells, as measured by a dissolved ozone sensor.

4b. In item 3b, where electrolytic cells are turned on and off in a way that ensures an approximately equal use of each cell over time, controlled by a unique electronic signature in the form of erasable programmable read-only memory, attached to each cell, allowing the control software to identify each cell as an individual unit, and control the use of each cell accordingly.

5b. Operation of multiple electrolytic cells, where each cell consists of two electrodes either side of a proton exchange membrane with which they are both in direct contact.

6b. In item 5b where each electrode has in the range of 0.25 to 2.5 cm² surface area in contact with the proton exchange membrane, such that each cell fits within water pipe diameters typical of those encountered in industrial and domestic scenarios.

7b. Electrolytic cells as outlined in items 5b and 6b where the proton exchange membrane between the two electrodes extends beyond the edges of the electrodes such that the membrane is larger than the length and width of the electrodes in every direction across the surfaces of the electrodes.

8b. Electrodes as outlined in items 5b and 6b where the principal material of construction of the electrodes is boron-doped diamond.

9b. Orientation of the multiple electrolytic cells referred to in the preceding items in a vertical or horizontal plane, such that water normally flows along the longitudinal plane of each microcell, including its electrodes and membrane, and that, when there is little or no water flow, water drains away from each microcell to reduce the growth of microorganisms on the surfaces of the cell.

10b. Provision of a means of isolating each electrolytic cell in the array so that it receives no water flow, nor applied electrical current, should the need arise.

11b. In item 10b where isolation of each electrolytic cell can be achieved either automatically via electronically-activated flow switches, valves and electrical switches, or manually, via actuated or manual valves and electrical switches, when either a cell requires investigation or replacement, or when an individual cell exceeds a maximum, predetermined voltage or temperature.

12b. In the event of a situation in items 9b and 10b, where an individual cell or number of electrolytic cells is or are isolated from water flow and electrical feed current, an equivalent number of off-line cells are brought on-line in order to equalise the production of anodic ozone across the multiple of cells.

13b. The use of multiple electrolytic cells as outlined in item 1b, where water is pumped, via one or more pumps, past the cells, into a water reservoir, and is then returned to the inlet side(s) of the pump or pumps so that the water now containing dissolved ozone receives further dissolved ozone from that produced at the anode of each cell, so that the concentration of dissolved ozone in the water within the reservoir gradually increases over time.

14b. In item 1b, where each electrolytic cell, although receiving separate electrical current from a discrete power source, are situated in water flow pipes, where the cross-section of the pipes is preferentially, but not exclusively circular, and the cells are spatially separated from one another.

15b. In preceding items where each electrolytic cell is contained either within a separate and distinct section of pipe, and each such section is situated in parallel with a neighbouring section or sections of pipe containing another or other cells, such that as water flows past each cell, the individual, parallel flows of water from each cell recombine to form either a single flow stream, or a single body of water, or both.

16b. In item 1b, where each of the electrolytic cells, although receiving separate electrical current from a discrete power sources, are situated in a single water flow pipe, where the cross-section of the pipes is preferentially, but not exclusively circular, and the cells are spatially separated from one another along its length.

17b. In preceding items where the flow of water after each electrolytic cell, or after a number of such cells in series, passes through a device to increase flow turbulence, and therefore gas-liquid contact area between any gas bubbles arising from the anode of the microcells and the bulk water in the pipe, thereby improving the dissolution of any ozone in the gas phase of the pipe.

18b. In item 17b where the device preferentially causes little or no drop in water pressure, where the device can include: static mixers, venturis, pipe restrictors and baffles on the inside of the pipe wall.

1. An apparatus for use in the production of ozone, the apparatus comprising:
i) a fluid manifold; and
ii) a plurality of electrolytic cells within the fluid manifold;
characterised in that each of the electrolytic cells are independently switchable between an on state and an off state.

2. An apparatus according to claim 1, wherein the plurality of electrolytic cells is connected in one of either series or parallel.

3. (canceled)

4. An apparatus according to claim 1, wherein the fluid manifold further comprises one or more conduits and each of the electrolytic cells are contained within one of either a common or a different conduit within the fluid manifold.

5. (canceled)

6. An apparatus according to claim 1, wherein the on state and the off state are one of either an electrically or a mechanically on state and an electrically off state respectively.

7. (canceled)

8. An apparatus according to claim 1, wherein each of the electrolytic cells are substantially the same.

9. An apparatus according to claim 1, further comprising a plurality of power supply units wherein each power supply unit provides power independently to each of the electrolytic cells respectively.

10. An apparatus according to claim 1, further comprising a tank within the fluid manifold.

11. An apparatus according to claim 10, wherein the tank comprises a vent.

12. An apparatus according to claim 1, further comprising a flow cell, said flow cell comprising an ozone sensor.

13. An apparatus for use in the production of ozone, the apparatus comprising:
i) a fluid manifold;
ii) one or more electrolytic cells within the fluid manifold; and
iii) a tank within the fluid manifold;
characterised in that the fluid manifold further comprises a flow cell, said flow cell comprising an ozone sensor.

14. An apparatus according to claim 13, wherein the tank comprises at least one of the following: an inlet for an aqueous solution an outlet for an ozonated solution, and a vent.

15. (canceled)

16. An apparatus according to claim 13, wherein the tank is open to the atmosphere.

17. An apparatus according to claim 13, wherein the apparatus comprises a plurality of electrolytic cells within the fluid manifold.

18. An apparatus according to claim 17, wherein each of the electrolytic cells are independently switchable between an on state and an off state.

19. An apparatus according to claim 13, wherein the fluid manifold comprises at least one of the following: a pump adapted to move fluid through the fluid manifold, one or more valves for controlling the passage of fluid through the fluid manifold, and a treatment loop.

20. (canceled)

21. (canceled)

22. An apparatus according to claim 13, wherein the apparatus further comprises a controller in communication with the fluid manifold.

23. An apparatus according to claim 13, wherein the electrolytic cell(s) comprises an anode and a cathode configured such that, in use with an aqueous solution, ozone is produced at the anode and hydrogen is produced at the cathode.

24. An apparatus according to claim 23, wherein the electrolytic cell(s) further comprises an ion exchange membrane between the anode and the cathode.

25. A process for the production of an ozonated solution, the process comprising the step of:
i) providing an apparatus according to claim 1;
ii) providing an aqueous solution to the apparatus; and
iii) electrolysing the aqueous solution using an electrolytic cell to generate ozone.

26. A computer program comprising instructions which, when the program is executed by a computer, cause the computer to carry out the method of claim 25.
